(19) United States
(12) Patent Application Publication
(10) Pub. No.: US 2017/0021434 A1
(43) Pub. Date: Jan. 26, 2017

(54) METHOD FOR PRODUCING A MACHINING TOOL AND MACHINING TOOL

(71) Applicant: KENNAMETAL INC., LATROBE, PA (US)

(72) Inventor: HERBERT RUDOLF KAUPER, ERLANGEN (DE)

(21) Appl. No.: 15/214,909

(22) Filed: Jul. 20, 2016

(30) Foreign Application Priority Data
Jul. 21, 2015 (DE) 102015213755.4

(51) Int. Cl. B23C 5/16; B23B 51/02

(52) U.S. Cl. CPC B23C 5/16; B23B 51/02; B23B 2228/10; B23B 2228/08; B23B 2228/36; B23C 2228/08; B23C 2228/10; B23C 2224/24; B23C 2224/32; B23C 2224/36; B23B 2224/32; B23B 2224/24; B23B 2224/04; B23C 2224/04

(57) ABSTRACT

In order to achieve a long service life for a machining tool, in particular for a solid carbide drill, it is provided with a special wear protection coating. In a first method step, in order to form this coating, a first layer made of a first material is applied in the region of a cutting edge and in the adjoining surface regions, and specifically, a flank face and a rake face. In a second step, the applied first material of the first layer is selectively removed at least partially, and preferably completely, only in the region of the cutting edge. Finally, in a third method step, a second layer made of a second wear-resistant material is applied both to the cutting edge and to the face regions. In this way, a coating having a high overall thickness in the face regions is made possible, without the risk of cracking.

### RELATED APPLICATION DATA

The present application claims priority pursuant to 35 U.S.C. §119(a) to German Patent Application Number 102015213755.4 filed Jul. 21, 2015 which is incorporated herein by reference in its entirety.

### FIELD

The invention relates to a method for producing a machining tool, in particular a rotary tool such as a drill or a milling cutter, which comprises a main body having a cutting edge, and further comprising a face region adjoining the cutting edge, specifically: a flank face and/or a rake face, wherein a wear protection coating is applied to the cutting edge and the face region. The invention further relates to a machining tool comprising a wear protection coating produced by said method.

### BACKGROUND

It is customary to apply a coating onto machining tools at least in the region of the blades so as to increase the wear resistance. The applied coatings may come in various embodiments. Nitride coatings such as TiN, TiAlN, TiSiN, TiCN, metallic oxide layers such as Al2O3, or boride coatings, in particular TiB2, are frequently applied.

To apply the layers, either the chemical vapor deposition (CVD) method or the physical vapor deposition (PVD) method is employed.

Multi-layer coatings for machining tools are known from DE 10 2009 001 765 A1, EP 1 762 637 B1, and DE 10 2008 009 487 A1.

The coating is usually applied by way of the PVD method to carbide machining tools, in particular to solid carbide drills or milling cutters. The CVD method is less suitable for this purpose, since the higher temperatures required with the CVD method may result in embrittlement of the carbide. PVD coatings are usually >1 μm thick, and rarely thicker than 10 μm. The layer thicknesses typically range between 3 μm and 6 μm.

In principle, the highest possible layer thickness is desired so as to achieve a long service life for the machining tool. When the coating is applied, however, residual stresses occur within the coating, which may result in cracking as the layer thickness increases. The layer thickness is therefore limited.

This problem is exacerbated with the PVD method, especially in the region of the cutting edge, since more coating particles are deposited on the cutting edge by virtue of the process, the result being that a thickened region is formed. The region of the cutting edge in particular is therefore at risk of cracking.

A special multi-layer coating composed of a TiAlN layer and an aluminum oxide layer for preventing comb cracks is known from DE 10 2009 001 765 A1, wherein these layers may be alternately applied. The main tool body to which the coating is applied is made of a carbide having a high content of cobalt.

DE 10 2008 009 487 A1 describes a mechanical post-treatment of brushing or blasting in order to reduce the residual stresses introduced during coating. It proposes to propel a fine-grained blasting abrasive having particle sizes up to approximately 600 μm onto the surface using compressed air.

Furthermore, a PVD-coated carbide insert can be found in EP 1 762 637 B2, which comprises a first layer made of (Ti, Al)N, additionally an aluminum oxide layer, and finally a ZrN layer. In the regions of the rake face and of the cutting edge, the outer ZrN layer is removed again by means of a post-treatment, preferably by way of brushing or blasting.

### SUMMARY

Proceeding from this, the task of the invention is to provide a method and a machining tool, in which a wear protection coating with a particularly long service life is applied.

The task is solved according to the invention by way of a method for producing a machining tool, in particular a rotary tool, and specifically a drill, a reamer or a milling tool, having the features of claim 1.

The method serves to apply a wear protection coating to a main body of a machining tool. The main body comprises a cutting edge, which is adjoined by a face region, specifically a flank face and/or a rake face. The cutting edge is in particular a main blade, which on a drill is positioned on the end face, for example. Alternatively or additionally, the cutting edge may also be a secondary blade, for example designed to extend along a flute in the case of a drill.

In order to apply the wear protection coating, the procedure is such that in a first step, a first layer made of a first material is initially applied to the region of the cutting edge and to the face region, which is subsequently removed again at least partially from selective spots only in the region of the cutting edge in a second step. Finally, in a third step, a second layer made of a second material is applied to the region of the cutting edge and to the face region. Each of the applied (coating) materials of the two respective layers is a wear-resistant material. Each layer therefore forms a wear protection layer.

Overall, this embodiment aims at enabling the application of a particularly thick coating in the face regions, specifically, in the region of the rake face and/or the flank face, while simultaneously preventing cracking, in particular in the region of the cutting edge. This process takes advantage of the fact that the problem of crack formation occurs especially at the cutting edge. The measure of the second method step, which is the removal of the first layer in the region of the cutting edge, advantageously results in the formation of a comparatively thin coating in the finished state in the region of the cutting edge, so that the risk of cracking in the region of the cutting edge is minimized.

This embodiment furthermore assumes that the load directly at the cutting edge is lower than in the subsequent face regions, so that a thinner coating in the region of the cutting edge will not adversely affect the service life. The reason for this can be seen in the fact that, during the machining process, the wedge action of the cutting edge already slightly breaks up the material to be removed ahead of the cutting edge, so that the load directly at the cutting edge is lower than in an adjoining face region, over which either the chip slides (rake face) or where alternatively the machining tool is supported on the workpiece (flank face).

‘Only in the region of the cutting edge’ means that the first layer is removed only at the cutting edge and in the directly abutting region of the respective adjoining face region. The first layer is in particular removed only at the cutting edge and by no more than 500 μm, preferably no more than 100 μm, in the direction of the adjoining face regions.

Preferably, the applied second layer forms a final end layer, and consequently no further coating layers are applied. In principle, a multi-layered structure may be provided. In the second step, it is also possible for a group of layers to be at least partially removed.

In order to achieve a preferably large overall layer thickness, each of the two layers in the respective face regions each has a respective layer thickness in the range of 2 μm to 10 μm, and in particular in the range of 4 μm to 8 μm. In particular, the second layer has a similar layer thickness, for example in the range of 3 μm to 9 μm. Overall, the total layer thickness in the face regions is more than 8 μm. Such a layer thickness, in particular when produced by way of a PVD method, would conventionally result in cracking at the cutting edge. As a result of the method introduced here, a comparatively thick coating is achieved in the region of the flank face and/or of the rake face, without fearing the risk of cracking.

Alternative to an embodiment in which the two layers have a comparable layer thickness, the layer thicknesses of the layers may differ from each other. Specifically, in this case, the first layer is thicker than the second layer by up to 75%, for example, or vice versa. One layer has a layer thickness of approximately 3 μm, for example, and the other layer has a layer thickness of approximately 5 μm.

Preferably, however, the two layers in the face region have at least approximately the same layer thickness. This means that the two thicknesses of the layers differ by no more than 20%, and preferably by no more than 5%. This measure results in the largest possible overall thickness, without the risk of cracking, which is typically to be expected starting at a certain layer thickness. Preferably, each individual layer has a layer thickness that is slightly less than such a critical layer thickness.

According to an expedient embodiment, in the second step, the first layer is completely removed in the region of the cutting edge. The second layer is therefore reapplied to the base material of the main body. This ensures a particularly good bonding between the coating and the main body. Expediently, in the second step, exactly the first layer only is completely removed, without material of the main body being removed as well.

The removal is preferably carried out mechanically, in particular by brushing or by grinding, for example, and in particular with the aid of a grinding paste. By means of appropriate process parameter settings, it is possible to remove the first layer with high precision and accuracy.

According to an expedient embodiment, the two layers are formed of an identical material. The same wear protection material is therefore applied to both layers. A homogeneous coating made of the same material is thus generated.

According to a preferred alternative, a multi-layered structure is composed of differing materials.

In principle, the coating materials can be any conventional coating materials that improve the wear protection and increase service life. In particular, nitride layers such as TiN, TiAlN, TiSiN, TiCrN, TiCN or TiAlSiN are formed for the coating. In addition to nitride layers, preferably, metallic oxide layers are also formed, such as aluminum oxide layers, or finally, as further alternatives, boride layers, in particular TiB2 layers.

In a preferred embodiment, the main body to which the coating is applied is made of carbide. Alternatively, it is a ceramic or a cermet main body.

At least one layer, and preferably both layers, are applied by way of a PVD method. Therefore, due to the lower temperature load during the coating process as compared to a CVD method, for example, embrittlement is largely prevented, in particular when a carbide main body is used.

The machining tool is in particular a rotary tool. This means: a tool which rotates about its center axis or its axis of rotation during operation. In particular, the machining tool is a drill, a reamer, or a milling tool. The preferred field of application is the drill.

Furthermore, in a preferred embodiment, the machining tool is a solid carbide machining tool, specifically, a machining tool in which the entire tool is made of carbide. ‘Entire tool’ means here in particular that it comprises a shank part for clamping into a machine tool and an adjoining blade. In a preferred embodiment, the entire tool, specifically, the shank part and the blade, is made of carbide.

The coating is applied in particular in the region of main blades, which in the case of a drill is at the end face of the blade. In addition, the special coating is expediently also applied in the region of the secondary blades, which typically extend along flutes.

In a preferred alternative, the coating is applied to a tool tip of a modular rotary tool in addition to its application to a solid carbide tool. A modular rotary tool is a tool in which a tool tip is exchangeably fastened in a carrier body. The tool tip, also referred to as the drill bit, is usually inserted into the end face of the carrier tool. Specifically, it is usually clamped centrally between two clamping strips of the carrier tool. This exchangeable tool tip, in turn, is preferably made of carbide, or alternatively of cermet or of a ceramic cutting material.

Alternatively, the coating may in principle also be applied to exchangeable cutting inserts, and in particular to indexable cutting inserts.

The invention is furthermore realized by a machining tool having the features of claim 13. The machining tool is provided with a coating, in particular by means of the above-described method. The presented advantages of preferred embodiments with regard to the method also apply correspondingly to the machining tool.

Therefore, in its finished state, the machining tool comprises a multi-layered structure made of two layers of a wear-resistant material in the face region, specifically, in the region of the rake face and/or the flank face. As a result of the method, the thickness of the first layer in the region of the cutting edge is reduced, as compared to the thickness of the first layer in the abutting face region, and preferably it is removed, meaning that the thickness is reduced to 0.

In the simplest case, the machining tool is a cutting element, such as an exchangeable tool tip or an exchangeable cutting insert. Preferably, however, the machining tool is in particular the entire tool comprising a clamping part for clamping into a machine tool, in particular a clamping shank, and an adjoining blade.

Furthermore, the overall thickness of the coating in the region of the cutting edge is expediently lower than in the adjoining face region.

In total, the overall thickness of the coating in the face region is more than 6 μm, or more than 8 μm, and in particular more than 10 μm, and in particular it is up to 16 μm. In this way, a very thick wear protection coating is formed, which ensures a long service life.

It is generally preferred if the coating is formed by the first and second layers both on the rake face and on the flank face, and if the first layer is removed only from the cutting edge.

### BRIEF DESCRIPTION OF THE DRAWINGS

One non-limiting embodiment of the invention is explained in greater detail based on the figures. In simplified illustrations:

FIG. 1 shows a side view of a solid carbide drill;

FIG. 2A shows a schematic sectional illustration in the region of a cutting edge comprising an applied first coating layer;

FIG. 2B shows the illustration according to FIG. 2A after the first layer was removed in the region of the cutting edge; and

FIG. 2C shows the illustrations according to FIGS. 2A, 2B after the third method step was completed, with the second coating layer applied.

Parts having the identical functions are marked with the same reference numbers in the figures.

### DETAILED DESCRIPTION

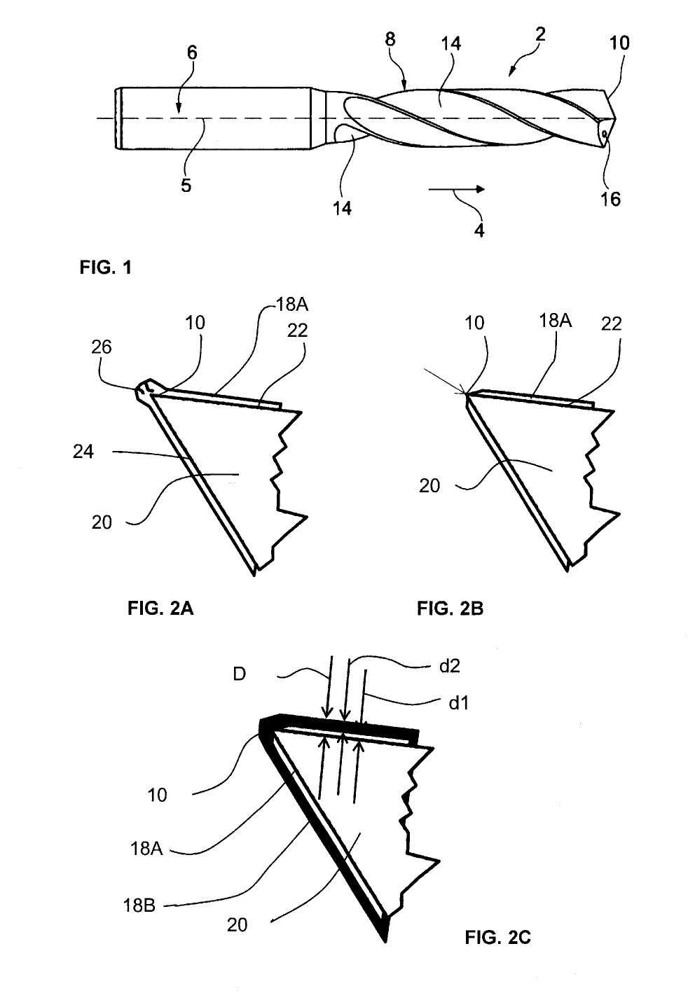

FIG. 1 shows a rotary tool which, in particular, is designed as a drill 2. The drill 2 extends in the longitudinal direction 4 along a center axis or an axis of rotation 5, around which the drill 2 rotates during operation. The drill 2 comprises a shank part 6 in the rear sub-region and a blade 8 in the front region. This extends up to a drill bit formed on the end face, which is usually formed by special point geometry and comprises main blades, which form the cutting edges 10. The blade 8 has an overall fluted design and in the exemplary embodiment it comprises spiral flutes 14. A secondary blade is usually formed along these flutes 14. In the exemplary embodiment, the drill 2 is designed with inside cooling channels, which exit at the end face at outlet holes 16.

In order to increase stability and wear resistance, a wear protection coating 18 is applied to the drill 2, in particular in the region of the cutting edges 10, and preferably in the entire blade 8. The special manufacturing method for applying this coating 11 will be described in more detail based on FIGS. 2A through 2C.

The coating 18 is generally applied to a main body 20. This body is in particular formed by the main body of the drill 2 and is specifically made of carbide. The drill 2 is in particular a solid carbide drill.

In a first method step, initially a first layer 18A of the coating 18 is applied to the main body 20, both in the region of the cutting edge 10 and in the adjoining face region, and specifically, to a flank face 22 and to a rake face 24. A first wear-resistant material is applied by way of the PVD method. The rake face 24 is in particular a flute face, and specifically, at least a sub-region of the flute 14.

The PVD application method creates a thickened region at the cutting edge 10, which favors the development of cracks 26.

In the second method step as shown in FIG. 2B, the first layer 18A is subsequently completely removed again in the region of the cutting edge 10 only, so that the cutting edge 10 itself is exposed again.

Finally, in the following third method step as shown in FIG. 2C, a second layer 18B is applied. Here, too, a second wear-resistant material is reapplied by way of the PVD method. The two materials are preferably the same wear-resistant material.

The first layer 18A has a layer thickness d1, and the second layer 18B has a layer thickness d2. In the exemplary embodiment, d1 is slightly lower than d2. Preferably, the layer thicknesses d1, d2, of the two layers 18A, 18B, generally range between 4 and 8 μm. In total, the coating 18 has an overall thickness D of >8 μm, and preferably >10 μm, up to 16 μm. The overall thickness D is measured for this purpose in the region of the flank face 22 or of the rake face 24 at a distance from the cutting edge 10, and specifically, in a region in which both layers 18A, 18B are formed.

The measure described herein in particular also prevents cracking in the critical region of the cutting edge 10, while achieving a comparatively high layer thickness in the face regions 22, 24, so that a long service life is achievable.

The concept described herein is not limited to the exemplary embodiment. The specially designed coating can be used not only for rotating tools, but for all machining tools in which a sharp, coated cutting edge is needed. In addition to drills/milling cutters, the coating concept is used in particular for superfinishing tools such as reamers, boring bars or hollowing tools.

1. A method for producing a machining tool which comprises a main body having a cutting edge, and further comprising a face region including a flank face and/or rake face adjoining the cutting edge, wherein a wear protection coating is applied to the cutting edge and to the face region, wherein for forming the coating,
in a first step, a first layer made of a wear-resistant material is initially applied to the cutting edge and to the face region;
subsequently, in a second step, the applied material of the first layer is selectively removed at least partially from the cutting edge; and
finally, in a third step, a second layer made of a wear-resistant material is applied to the cutting edge and to the face region.

2. The method according to claim 1, wherein the first and second layers in the face region each have a layer thickness (d1, d2) in the range of 2 μm to 10 μm.

3. The method according to claim 1, wherein a combined thickness (D) of the first and second layers in the face region is greater than 8 μm.

4. The method according to claim 1, wherein the first and second layers in the face region have the same layer thickness (d1, d2).

5. The method according to claim 1, wherein in the second step, the first layer in the region of the cutting edge is completely removed.

6. The method according to claim 1, wherein in the second step, the material of the first layer in the region of the cutting edge is mechanically removed.

7. The method according to claim 1, wherein the wear-resistant material of the first layer is the same as the wear-resistant material of the second layer.

8. The method according to claim 1, wherein differing materials are selected for the first layer and for the second layer.

9. The method according to claim 1, wherein the first and second layers are independently formed as nitride layers such as TiN, TiAlN, SiN, TiCrN, TiCN, TiAlSiN, as metallic oxide layers such as Al2O3, or as boride layers.

10. The method according to claim 1, wherein the main body is made of carbide.

11. The method according to claim 1, wherein the first and second layers are applied by way of a PVD method.

12. The method according to claim 1, wherein the coating is applied to a main body or tip of a rotary tool.

13. A machining tool comprising a main body having a cutting edge and a face region comprising a flank face and/or rake face abutting the cutting edge, wherein a wear protection coating is applied to the cutting edge and to the face region, the coating comprising a first layer that is applied to the main body and an outer second layer that is applied to the first layer, wherein the thickness (d1) of the first layer is at least reduced in the region of the cutting edge compared to the thickness (d2) of the first layer in the face region.

14. The machining tool according to claim 13, wherein overall thickness of the coating is lower in the region of the cutting edge than in the face region.

15. The machining tool according to claim 13, wherein overall thickness of the coating in the face region is greater than 8 μm and is up to 16 μm.

16. The machining tool according to claim 13, wherein the coating is applied to a main bod or tip of a rotary tool.

17. The machining tool according to claim 16, wherein machining tool is formed of solid carbide.
